(19) United States
(12) Patent Application Publication
(10) Pub. No.: US 2026/0121409 A1
(43) Pub. Date: Apr. 30, 2026

(54) METHOD FOR OPERATING A MICROGRID, COMPUTER PROGRAM, CONTROL DEVICE FOR CONTROLLING A MICROGRID, AND MICROGRID

(71) Applicant: Rolls-Royce Solutions GmbH, Friedrichshafen (DE)

(72) Inventors: Muhammet Hasan Sinat, Berlin (DE); Issam El Bakkali, Berlin (DE)

(73) Assignee: Rolls-Royce Solutions GmbH, Friedrichshafen (DE)

(21) Appl. No.: 19/374,631

(22) Filed: Oct. 30, 2025

(30) Foreign Application Priority Data
Oct. 30, 2024 (EP) 24209989.3

(51) Int. Cl. H02J 3/00

(52) U.S. Cl. CPC H02J 3/003; H02J 2103/30

(57) ABSTRACT

A method for operating a microgrid includes: calculating, based on historical data including a historical input vector of an input quantity, a historical output vector of two output quantities of the microgrid, and a reference trajectory including target values for the two output quantities, a control input vector by minimizing a deviation between the plurality of target values and a predicted output vector, the microgrid including a power source and a dynamic load, the power source and the dynamic load being electrically coupled via an AC bus as a common connecting point; and controlling the power source with a subset of the control input vector as an actual control vector; wherein the two output quantities include a voltage amplitude and a frequency at the AC bus, and the reference trajectory includes nominal values for the voltage amplitude and the frequency as the target values.

### CROSS REFERENCE TO RELATED APPLICATIONS

This application claims priority to European patent application no. 24209989.3, entitled “DATA-DRIVEN CONTROL OF FREQUENCY AND VOLTAGE OF ISOLATED POWER GRIDS AC BUS UNDER FAST LOAD CHANGES”, filed Oct. 30, 2024, which is incorporated herein by reference.

### BACKGROUND OF THE INVENTION

### 1. Field of the Invention

The present invention relates to a microgrid.

### 2. Description of the Related Art

An isolated AC power grid, also referred to as a microgrid, which is powered by at least one power source, or distributed generating assets, such as power electronics power conversion systems or conventional rotating generators, distributed particularly in the sense that they do not communicate with each other, but only receive setpoints from a superseding central controller, has its output quantities at an AC bus as a common connecting point, such as voltage and frequency, typically deviating from desired nominal values in the case of fast load ramps on a time scale of, e.g. less than one second. Only after a certain time the nominal values are again reached. However, heavy oscillations may happen, and in severe cases these oscillations remain in steady-state, i.e., the nominal voltage and frequencies are not reached at all. This phenomenon is especially observable when a control latency—in particular caused by a measurement latency—is larger than a few tens of milliseconds. Conventional control devices are not designed for latencies as large as, e.g. 500 ms, as they cannot guarantee that the voltage and frequency at the AC bus converge to the nominal values following a load ramp.

What is needed in the art is a method for operating a microgrid, a computer program, a control device for controlling a microgrid, and a microgrid which optionally at least in part overcomes the above stated issues.

### SUMMARY OF THE INVENTION

The invention relates to a method for operating a microgrid, a computer program, a control device for controlling a microgrid, and a microgrid.

According to a first aspect, the present invention provides a method for operating a microgrid, wherein the microgrid includes at least one power source and at least one dynamic load, the at least one power source and the at least one dynamic load being electrically coupled via an AC bus as a common connecting point, wherein
in a first step S1: based on historical data including a historical input vector of at least one input quantity, a historical output vector of at least two output quantities of the microgrid, and a reference trajectory including target values for the at least two output quantities, a control input vector is calculated by minimizing a deviation between the target values and a predicted output vector, optionally using a direct data driven or behavioral predictive algorithm, wherein
in a second step S2: the at least one power source is controlled with at least a subset of the control input vector as an actual control vector, and wherein
the at least two output quantities include a voltage amplitude and a frequency at the AC bus, and the reference trajectory includes nominal values for the voltage amplitude and the frequency as the target values.

By calculating the control input vector based on historical data and the reference trajectory including the target values for the at least two output quantities, i.e. nominal values for the voltage amplitude and the frequency, the output quantities can easily achieve a speedy and steady return to their nominal values, without showing heavy oscillations or persistent deviations from the target values after undergoing a load ramp, even in less than one second. Further, it is not necessary to have or establish a physical or parametric model for the microgrid in order to achieve these results. Still further, the method easily provides for handling even larger control latencies of the order of, e.g., 500 ms.

Optionally, the method is repeated—i.e. the first and second steps S1 and S2 are repeated—with a frequency from 0.2 Hz to 100 Hz, optionally from 0.5 Hz to 50 Hz, optionally from 0.7 Hz to 20 Hz, optionally from 1 Hz to 10 Hz. In particular in this case, a most speedy return to the nominal values can be achieved even in the case of fast load ramps of less than one second.

In the context of the present technical teachings, a microgrid is in particular understood to mean a local electrical grid which is at least capable to operate in an island mode. The island mode is a mode in which the microgrid operates electrically isolated from—or in other words not connected to—a wider electric power system such as a supra-regional, national or transnational power grid. In an embodiment, the microgrid is operated in the island mode. However, it is conceivable that the microgrid additionally is capable to be operated in a grid-connected mode, synchronous with a larger grid such as a supra-regional, national or transnational power grid.

In particular, the microgrid is adapted to control frequency and voltage amplitude at the common connecting point, namely the AC bus, independent from external requirements or provisions.

In the context of the present technical teachings, a dynamic load is in particular understood to mean a load which varies in time, and in particular undergoes load ramps, namely when load is absorbed or thrown off, in particular on fast time scales of less than one second.

In an embodiment, the control input vector is calculated, in the first step S1, by minimizing the deviation between the target values and the predicted output vector using a direct data driven or behavioral predictive algorithm.

In the alternative, or additionally, in the first step S1, the control input vector is calculated by minimizing the deviation between the target values and the predicted output vector using the historical data as observed raw data included in prior knowledge of the microgrid.

In the alternative, or additionally, in the first step S1, the control input vector is calculated by minimizing the deviation between the target values and the predicted output vector using the historical data as observed raw data included in prior knowledge of the microgrid to achieve a direct map from the historical data to the control input vector without an identification of a model.

In the context of the present technical teachings, a direct data driven or behavioral predictive algorithm is in particular understood to mean an algorithm which is not based on a (parametric) model, but uses observed raw data—the historical data—as prior knowledge about a system, the system being the microgrid in this case. In particular, such a data-driven algorithm sometimes is described as a nonparametric model.

In an embodiment, in the first step S1, the control input vector is calculated further based on an initial input vector of the at least one input quantity and an initial output vector of the at least two output quantities—the initial input vector and the initial output vector being collectively labelled “initial data” in the following—, wherein, in the second step S2, an actual output vector of the at least two output quantities is measured upon controlling the at least one power source with the actual control vector, and wherein the first and second steps S1 and S2 are repeated, wherein, in the first step S1—particularly starting from the second iteration—, the initial input vector is updated with the actual control vector, and the initial output vector is updated with the actual output vector. Thus, the algorithm advantageously uses data—the initial data—, and prior knowledge—the historical data—, to predict the control input vector, and the initial data is updated in each step such that the algorithm can rapidly react to any changes.

In the context of the present technical teachings, that a vector is “updated” is in particular understood to mean that a certain number of the first vector elements is cancelled, the remaining vector elements are rearranged to replace the cancelled elements, i.e. to fill the gap, and the same certain number of the last vector elements, where finally the gap remains, are replaced by new values, in particular in accordance with a first in first out scheme.

In an embodiment, Data-Enabled Predictive Control (DeePC) is used as the behavioral or direct data driven predictive algorithm, as outlined, e.g., in: J. Coulson, J. Lygeros and F. Dörfler, “Data-Enabled Predictive Control: In the Shallows of the DeePC,” 2019, 18th European Control Conference (ECC), Naples, Italy, 2019, pp. 307-312, and I. Markovsky, L. Huang, and F. Dörfler, “Data-driven control based on the behavioral approach: From theory to applications in power systems,” IEEE Control Systems Magazine, vol. 43, no. 5, pp. 28-68, 2023. This is a particularly advantageous design of the method which is both reliable and cost-effective in computing performance.

In an embodiment, at least two input quantities are used as the at least one input quantity.

Optionally, the at least one power source includes a DC power source and a voltage source converter, optionally an inverter, wherein the at least one power source is electrically coupled to the common connecting point via the voltage source converter.

Optionally, the at least two input quantities are an active power and a reactive power. In particular in this way the microgrid is capable to control both frequency and voltage amplitude at the AC bus independent of external requirements or provisions in the island mode. The frequency is optionally controlled by a respective variation of the active power, and the voltage amplitude is controlled by a respective variation of the reactive power.

Without wanting to be bound by theory, a DeePC algorithm makes use of historical data given as a historical vector h:

$$h = {( {u}^{d} , {y}^{d} )}^{T} , \qquad ( 1 )$$

with the historical input vector

$${u}^{d} = {( {u}_{0}^{d} , … , {u}_{T - 1}^{d} )}^{T} , \qquad ( 2 )$$

and the historical output vector

$${y}^{d} = {( {y}_{0}^{d} , … , {y}_{T - 1}^{d} )}^{T} , \qquad ( 3 )$$

each including elements for T discrete time steps, wherein further each element is itself a vector including as many elements as there are input quantities and output quantities, respectively,—in general p output quantities and m input quantities, in the present case p=m=2, in particular:

$${u}_{i}^{d} = {( {P}_{i}^{d} , {Q}_{i}^{d} )}^{T} , \qquad ( 4 )$$

with the historical active power

$${P}_{i}^{d}$$

and the historical reactive power

$${Q}_{i}^{d}$$

at the i^{th} time step, and

$${y}_{i}^{d} = {( {f}_{i}^{d} , {U}_{i}^{d} )}^{T} , \qquad ( 5 )$$

with the historical frequency

$${f}_{i}^{d}$$

and the historical amplitude

$${U}_{i}^{d}$$

at the i^{th} time step.

Next, Hankel matrices [symbol] (u^{d}), [symbol] (y^{d}) with depth—i.e. number of rows—L, with T≥L, are constructed based on the historical vectors, and the rows of these Hankel matrices are divided using an—arbitrary—integer N such that:

$$L = {T}_{ini} + N , \qquad ( 6 )$$

yielding:

$$( \begin{matrix}{U}_{p} \\ {U}_{f}\end{matrix} ) := {ℋ}_{{T}_{ini} + N} ( {u}^{d} ) , \qquad ( 7 )$$

$$( \begin{matrix}{Y}_{p} \\ {Y}_{f}\end{matrix} ) := {ℋ}_{{T}_{ini} + N} ( {y}^{d} ) , \qquad ( 8 )$$

wherein Uₚ, Yₚ each represent the first Tᵢₙᵢ block rows of the respective Hankel matrix in (7) and (8), respectively, and U_{f}, Y_{f} each represent the last N block rows of the respective Hankel matrix in (7) and (8), respectively.

According to Willems' fundamental lemma, if a component of a response signal of a controllable linear time-invariant system is persistently exciting of sufficiently high order, then the windows of the signal span the full system behavior. The lemma is applied to obtain conditions under which the state trajectory of a state representation spans the whole state space (Jan C. Willems, Ivan Markovsky, Paolo Rapisarda, and Bart L. M. De Moor, “A Note on Persistency of Excitation,” 43^{rd} IEEE Conference on Decision and Control December 14-17, 2004 Atlantis, Paradise Island, Bahamas). In particular, the signals u^{d}, y^{d} are persistently exciting of order L if the Hankel matrices [symbol] (⋅) are of full rank.

The reference trajectory is given as

$$r = ( {r}_{0} , {r}_{1} , … ) , \qquad ( 9 )$$

which is a temporal sequence of reference vectors rᵢ at subsequent time steps i, each reference vector including a target value for the at least one output quantity, which is here:

$${r}_{i} = {( {f}_{tar , i} , {U}_{tar , i} )}^{T} , \qquad ( 10 )$$

with the target frequency f_{tar,i} and the target voltage amplitude U_{tar,i} at time step i.

The target frequency f_{tar,i} and the target voltage amplitude U_{tar,i} may be constant nominal values, namely constant for each time step i, e.g., 50 Hz and 230 V for Europe, or 60 Hz and 110 V for the USA.

The initial data is provided as an initial input vector (having Tᵢₙᵢ vector-valued elements, and thus m×Tᵢₙᵢ scalar elements)

$${u}_{ini} = {( {u}_{ini , 0} , {u}_{ini , 1} , … , {u}_{ini , {T}_{ini} - 1} )}^{T} , \qquad ( 11 )$$

with

$${u}_{ini , i} = {( {P}_{ini , i} , {Q}_{ini , i} )}^{T} , \qquad ( 12 )$$

with initial active power values P_{ini,i} and reactive power values Q_{ini,i} for each element i, and an initial output vector (having Tᵢₙᵢ vector-valued elements, and thus p×Tᵢₙᵢ scalar elements)

$${y}_{ini} = {( {y}_{ini , 0} , {y}_{ini , 1} , … , {y}_{ini , {T}_{ini} - 1} )}^{T} , \qquad ( 13 )$$

with

$${y}_{ini , i} = {( {f}_{ini , i} , {U}_{ini , i} )}^{T} , \qquad ( 14 )$$

with initial frequency values f_{ini,i} and voltage amplitude values U_{ini,i} for each element i.

Further, a set of constraints may be given as:

$$𝒰 ⊆ {ℝ}^{m} , \qquad ( 15 )$$

as an input constraint for the m input quantities, here with m=2, and

$$𝒴 ⊆ {ℝ}^{p} , \qquad ( 16 )$$

as an output constraint for the p output quantities, here with p=m=2, and an output cost matrix

$$Q ∈ {ℝ}^{p \times p} , \qquad ( 17 )$$

and a control cost matrix

$$R ∈ {ℝ}^{m \times m} , \qquad ( 18 )$$

However, in an optional embodiment, the control cost matrix R is 0, since signals are generated to which it is hard—or even meaningless—to assign any costs.

In an embodiment, as the control input vector u, a sequence of N>1 subsequent control vectors uᵢ is calculated. Optionally, also the predicted output vector y is calculated as a sequence of N>1 subsequent predicted output vectors yᵢ.

The control input vector u—having the subsequent control vectors uᵢ as N vector-valued elements, and thus m×N scalar elements—and the predicted output vector y—having the subsequent predicted output vectors yᵢ as N vector-valued elements, and thus p×N scalar elements—are now calculated for a prediction horizon of N time steps by solving the following problem at a current time step t, with summation over time steps j and 0<t<N−1:

$${min}_{g , u , y} {\sum }_{j = 0}^{N - 1} ( {‖ {y}_{j} - {r}_{t + j} ‖}_{Q}^{2} + {‖ {u}_{j} ‖}_{R}^{2} )$$

subject to:

$$( \begin{matrix}{U}_{p} \\ {Y}_{p} \\ {U}_{f} \\ {Y}_{f}\end{matrix} ) g = ( \begin{matrix}{u}_{ini} \\ {y}_{ini} \\ u \\ y\end{matrix} ) \\ {u}_{j} ∈ 𝒰 , ∀ j ∈ \{ 0 , … , N - 1 \} \\ {y}_{j} ∈ 𝒴 , ∀ j ∈ \{ 0 , … , N - 1 \} . \qquad ( 19 )$$

with:

$${‖ x ‖}_{X}^{2} := {x}^{T} Xx \qquad ( 20 )$$

for any vector x and Matrix X.

Optionally only a subset of k<N of the subsequent control vectors uᵢ-k being referred to as control horizon—are used as the actual control vector uₐ with elements u_{a,j}:

$${u}_{a , j} = {u}_{j} , ∀ j ∈ \{ 0 , … , k - 1 \} . \qquad ( 21 )$$

The microgrid is controlled in the time window from (t+1) to t+k with the actual control vector uₐ:

$${u}_{a , j} = {u}_{a}^{t + 1 + j} , ∀ j ∈ \{ 0 , … , k - 1 \} . \qquad ( 22 )$$

equation (22) meaning that the element u_{a,j} (which itself is a vector including an active power value and a reactive power value as vector elements) is used to control the at least one power source at the time step t+1+j.

The actual output vector yₐ is measured upon controlling the at least one power source as the response of the microgrid to the control and any further changes in the time window from (t+1) to t+k, such as load changes, yielding

$${y}_{a} = {( {y}_{a , 0} , … , {y}_{a , k - 1} )}^{T} , \\ and \qquad ( 23 )$$

$${y}_{a , j} = {y}_{j}^{t + 1 + j} , ∀ j ∈ \{ 0 , … , k - 1 \} , \qquad ( 24 )$$

equation (24) meaning that the element y_{a,j} (which itself is a vector including a frequency value and a voltage amplitude value as vector elements) is measured at the time step t+1+j.

In an embodiment, N equals from 5 to 70, optionally from 10 to 50. This choice, in particular, makes sure that the voltage and frequency at the AC bus converge to the nominal values following a load ramp on a short time scale, even with latencies as large as, e.g. 500 ms.

Additionally, or in the alternative, k equals from 1 to 3, optionally k equals 1. Advantageously, the algorithm allows for a very precise prediction when k is in this range or has the respective value.

In the subsequent time step t′=t+k, the initial data is updated by setting—the equals sign being understood as an assignment operator in the following equations (25) to (28)—:

$${u}_{ini , i} = {u}_{ini , i + k} , ∀ i ∈ \{ 0 , … , {T}_{ini} - 1 - k \} \qquad ( 25 )$$

$${u}_{ini , i} = {u}_{a , j = i - ( {T}_{ini} - k )} , ∀ i ∈ \{ {T}_{ini} - k , … , {T}_{ini} - 1 \} and j ∈ \{ 0 , … , k - 1 \} \qquad ( 26 )$$

$${y}_{ini , i} = {y}_{ini , i + k} , ∀ i ∈ \{ 0 , … , {T}_{ini} - 1 - k \} \qquad ( 27 )$$

$${y}_{ini , i} = {y}_{a , j = i - ( {T}_{ini} - k )} , ∀ i ∈ \{ {T}_{ini} - k , … , {T}_{ini} - 1 \} and \\ j ∈ \{ 0 , … , k - 1 \} , \qquad ( 28 )$$

and the process is repeated by solving the problem of equation (19) at the time step t′=t+k.

Optionally, this scheme is iterated in an ongoing manner during the operation of the microgrid.

In an embodiment, a single time step has length of 10 ms to 5 s, optionally from 20 ms to 2 s, optionally from 50 ms to 1.5 s, optionally from 100 ms to 1 s. Thus, the whole iteration is repeated with a frequency from 0.2 Hz to 100 Hz, optionally from 0.5 Hz to 50 Hz, optionally from 0.7 Hz to 20 Hz, optionally from 1 Hz to 10 Hz.

In an embodiment, in a first step, (19) is solved at the time step t for an optimal g*; in a second step, an optimal control input vector u* is calculated as

$${u}^{*} = {U}_{f} {g}^{*} ; \qquad ( 29 )$$

in a third step, the actual control vector uₐ is constructed of the first k elements of u*; and in a fourth step, at the subsequent time t′=t+k, the initial data is updated according to equations (25) to (28). In a fifth step, the first step is repeated at the time step t′=t+k, and so forth. In particular, since optionally R=0, the last term of the sum in (19) vanishes, and one can calculate a multitude of different vectors g′, from solving Uₚ g=uᵢₙᵢ or Yₚ g=yᵢₙᵢ, then calculate a y′=Y_{f}g′ for each g′, then optimize g′ and y′ by minimizing the sum of (19) to obtain the optimal g* in the first step, and finally calculate u* from (29) in the second step.

In an embodiment, a more sophisticated problem (19′) is used instead of (19) in order to adapt to noise:

$${min}_{g , u , y} {\sum }_{j = 0}^{N - 1} ( {‖ {y}_{j} - {r}_{t + j} ‖}_{Q}^{2} + {‖ {u}_{j} ‖}_{R}^{2} ) + {λ}_{g} {‖ g ‖}_{1} + {λ}_{y} {‖ {σ}_{y} ‖}_{1}$$

subject to:

$$( \begin{matrix}{\hat{U}}_{p} \\ {\hat{Y}}_{p} \\ {\hat{U}}_{f} \\ {\hat{Y}}_{f}\end{matrix} ) g = ( \begin{matrix}{u}_{ini} \\ {y}_{ini} \\ u \\ y\end{matrix} ) + ( \begin{matrix}0 \\ {σ}_{y} \\ 0 \\ 0\end{matrix} ) \\ {u}_{k} ∈ 𝒰 , ∀ k ∈ \{ 0 , … , N - 1 \} \\ {y}_{k} ∈ 𝒴 , ∀ k ∈ \{ 0 , … , N - 1 \} , \qquad ( {19}^{′} )$$

with an auxiliary slack variable σ_{y}ϵ [symbol] , and regularization parameters λ_{g}, λ_{y}ϵ [symbol] , and (Ûₚ Îₚ Û_{f} Ý_{f})^{T} representing a low-rank matrix approximation of (Uₚ Yₚ U_{f} Y_{f})^{T}.

In particular, the regularization parameters λ_{g}, λ_{y}, the parameters T, N, Tᵢₙᵢ, and the Matrices Q and R are hyperparameters of the algorithm which are optionally optimized.

In particular, the regularization parameter λ_{g} is primarily used to manage inexact data. Regularization is applied to address issues that arise from noise, disturbances, or discrepancies between the true data-generating system. (e.g., when the system is not perfectly linear time-invariant (LTI)). The parameter λ_{g} controls the degree of regularization, striking a balance between fitting the model closely to the data and maintaining the desired system behavior. This balance may be relevant for robust performance, particularly in the presence of data imperfections. λ_{y} specifically pertains to the output. This parameter controls the trade-off between the fidelity of the model's output and its ability to generalize. Essentially, λ_{y} determines how strictly the model's output should adhere to the observed data versus allowing some deviation to potentially achieve better generalization or robustness, particularly in the presence of noise. The output cost matrix Q is intended to penalize tracking errors. By tuning Q, the system's tracking performance can be enhanced, and control errors can be minimized.

In an embodiment, Tis at least 200, optionally at least 500, optionally at least 800, optionally not greater than 1000. In addition, or in the alternative, λ_{g} may be chosen to be at most 1000, optionally at most 500, optionally at most 100. In addition, or in the alternative, λ_{y}, may be chosen to be at most 5000, optionally at most 2500, optionally at most 1000, optionally at most 100.

In an embodiment, as the at least one power source a grid forming voltage source converter is controlled. Advantageously, the microgrid can be completely governed in the island mode by controlling the grid forming voltage source converter in order to define and maintain both voltage amplitude and frequency.

In the context of the present technical teachings, a grid forming voltage source converter is understood to mean a converter which can adjust its output power and voltage amplitude, in particular in response to grid conditions, and optionally to coordinate with other power sources to balance supply and demand. In particular, a grid forming converter is a converter which is able to adjust its output active power and reactive power, in particular to maintain stable values for frequency and voltage amplitude even upon load changes.

Optionally, the grid forming voltage source converter is an inverter.

In an embodiment, additionally at least one grid following voltage source converter is controlled as a further power source of the at least one power source. Advantageously, additional power sources can be integrated into the microgrid in order to meet larger power demands. The at least one grid following voltage source converter may follow the grid forming voltage source converter.

In the context of the present technical teachings, a grid following voltage source converter is understood to mean a converter which is adapted to synchronise its output with voltage and frequency on a grid.

Optionally, the grid following voltage source converter is an inverter.

In an embodiment, a static load is electrically coupled to the common connecting point.

In an embodiment, the at least one power source is a constant—or controllable—power source. This is in particular beneficial in combination with a grid forming voltage source converter in order to guarantee stable and persistent values for both frequency and voltage amplitude.

In the context of the present technical teachings, a constant and/or controllable power source is understood to mean a power source which can provide constant, yet optionally controllable or adjustable power on a timescale of at least an hour, optionally at least several hours, optionally at least several days.

In an embodiment, such constant—and/or controllable—power source includes an energy storage device in combination with a voltage source converter, wherein optionally the energy storage device is a mechanical, electrochemical, magnetic, thermal or chemical energy storage device, optionally a battery.

In the alternative, the at least one power source is a variable power source. With the method disclosed herein, it is advantageously possible to stably and easily use variable power sources in the microgrid.

In the context of the present technical teachings, a variable power source is understood to mean a power source which provides varying power depending on external circumstances.

In an embodiment, such a variable power source is a renewable energy source, in particular a wind turbine or a photovoltaic plant.

In an embodiment, the microgrid includes at least two power sources, namely at least one constant—and/or controllable—power source as a first power source, and at least one variable power source as a second power source.

In an embodiment, the historical data is provided prior to operating the microgrid.

Optionally, the historical data is provided from prior test runs or a simulation. This is the simplest way to implement the method.

Additionally, or in the alternative, the historical data is collected and updated during operation of the microgrid. In this case, the algorithm advantageously can be further updated in addition to updating the initial data; thus, the algorithm is particularly flexible and able to react to even unforeseen developments—both internal and external.

In an embodiment, the microgrid includes more than one power source, and the method includes droop control for load sharing between the power sources, optionally both for frequency and voltage amplitude. The method may further include supervisory control to complement the droop control, in particular to adapt, in particular shift, the droop slopes upon load changes in order to maintain constant values for frequency and voltage amplitude.

In an embodiment, the microgrid is operated in an island mode.

According to a second aspect, the present invention provides a computer program including instructions which, when the program is executed by a computer, cause the computer to carry out a method according to the invention, or at least according to any of the above-disclosed embodiments of the method. With respect to the computer program, in particular the same advantages are achieved as explained above in relation to the method.

According to a third aspect, the present invention provides a control device for controlling a microgrid, the control device being adapted to carry out a method according to the invention, or according to at least one of the above-disclosed embodiments of the method. With respect to the control device, in particular the same advantages are achieved as explained above in relation to the method or the computer program.

In an embodiment, the control device is adapted to employ droop control in order to manage load sharing between different power sources, optionally both for frequency and voltage amplitude. The control device may further be adapted to employ supervisory control to complement the droop control, in particular to adapt, in particular shift, the droop slopes upon load changes in order to maintain constant values for frequency and voltage amplitude.

According to a fourth aspect, the present invention provides a microgrid having at least one power source and at least one dynamic load, wherein the at least one power source and the at least one dynamic load are electrically coupled via an AC bus as a common connecting point, wherein the microgrid further includes a control device according to the invention or according to at least one of the above-disclosed embodiments of the control device, the control device being operatively connected to and adapted to control the at least one power source. With respect to the microgrid, in particular the same advantages are achieved as explained above in relation to the method, the computer program or control device.

In an embodiment, the microgrid includes, as the at least one power source, an energy storage device in combination with a voltage source converter. The energy storage device may be a mechanical, electrochemical, magnetic, thermal or chemical energy storage device, optionally a battery. The voltage source converter optionally is an inverter.

In an embodiment, the microgrid further includes a renewable energy source, optionally a photovoltaic plant or a wind turbine, as the at least one power source.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows an embodiment of a microgrid having an embodiment of a control device; and

FIG. 2 shows a schematic representation of an embodiment of a method for operating the microgrid.

Corresponding reference characters indicate corresponding parts throughout the several views. The exemplifications set out herein illustrate at least one embodiment of the invention, and such exemplifications are not to be construed as limiting the scope of the invention in any manner.

### DETAILED DESCRIPTION OF THE INVENTION

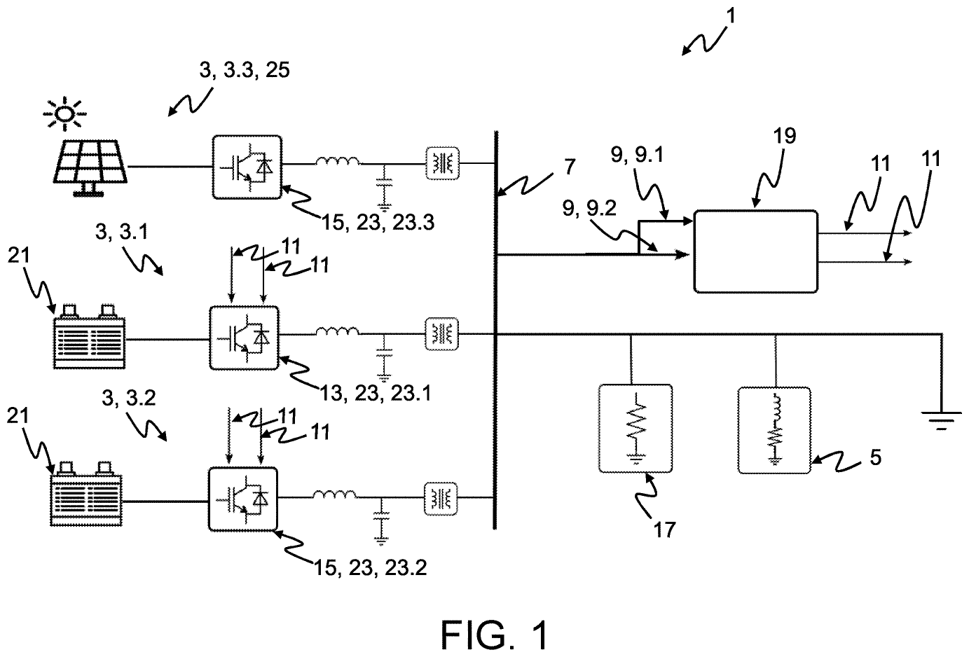

FIG. 1 shows an embodiment of a microgrid 1 including an embodiment of a control device 19, the control device 19 being adapted to carry out an embodiment of a method for operating a microgrid 1.

The microgrid 1 has at least one power source 3 and at least one dynamic load 5, wherein the at least one power source 3 and the at least one dynamic load 5 both are electrically coupled via an AC bus as a common connecting point 7. The control device 19 is operatively connected to and adapted to control the at least one power source 3.

As depicted in FIG. 1, the microgrid 1 includes, as the at least one power source 3, a first power source 3.1, which includes an energy storage device 21 in combination with a voltage source converter 23 as a first voltage source converter 23.1. The microgrid 1 further includes a second power source 3.2, which also includes an energy storage device 21 in combination with a voltage source converter 23 as a second voltage source converter 23.2. The energy storage devices 21 each may be a mechanical, electrochemical, magnetic, thermal or chemical energy storage device; optionally it is a battery.

In particular, the first voltage source converter 23.1 is a grid forming voltage source converter 13. Further, the second voltage source converter 23.2 is a grid following voltage source converter 15.

The embodiment of the microgrid 1 further includes a renewable energy source, optionally a photovoltaic plant 25 or a wind turbine, as a third power source 3.3, having a third voltage source converter 23.3, which is a grid following voltage source converter 15.

The first and second power sources 3.1, 3.2 are controllable power sources 3, and the third power source 3.3 is a variable power source 3.

Optionally, the control device 19 is adapted to employ droop control in order to manage load sharing between the different power sources 3, optionally both for frequency and voltage amplitude. The control device 19 may further be adapted to employ supervisory control to complement the droop control, in particular to adapt, in particular shift, the droop slopes upon load changes in order to maintain constant values for frequency and voltage amplitude.

A static load 17 may electrically be coupled to the common connecting point 7.

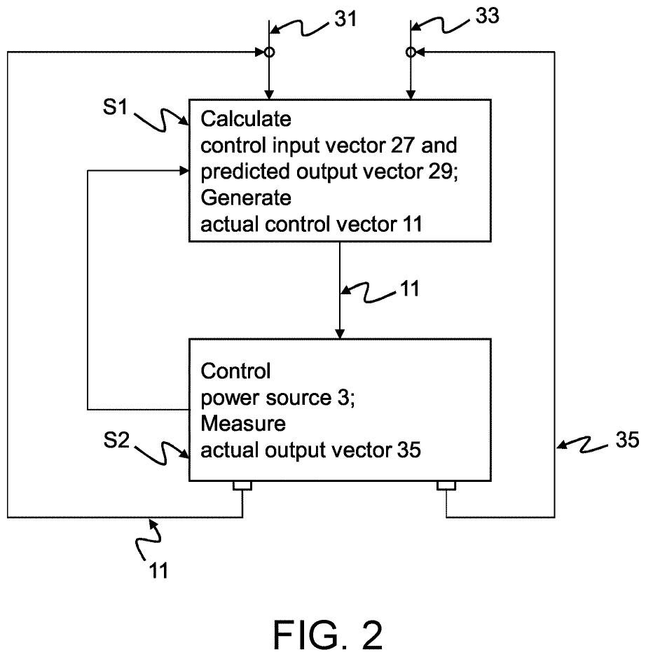

FIG. 2 shows a schematic representation of an embodiment of the method for operating the microgrid 1.

In a first step S1, based on historical data including a historical input vector of two input quantities of the microgrid, namely active power and reactive power, and a historical output vector of at least two output quantities 9 of the microgrid 11, namely a voltage amplitude 9.1 and a frequency 9.2—see FIG. 1—at the common connecting point 7, and a reference trajectory including target values, e.g. 50 Hz and 230 V, for the at least two output quantities, a control input vector 27 is calculated by minimizing a deviation between the target values and a predicted output vector 29, optionally using a direct data driven or behavioral predictive algorithm, in particular Data-Enabled Predictive Control (DeePC) in accordance with one of equations (19) or (19′) given above. In the alternative, or additionally, the historical data is used as observed raw data included in prior knowledge of the microgrid, optionally to achieve a direct map from the historical data to the control input vector without an identification of a model.

In a second step S2, at least one of the power sources 3 is controlled with an actual control vector 11—see FIG. 1—, the actual control vector 11 being at least a subset of the control input vector 27.

Optionally, in the first step S1, the control input vector 27 is calculated further based on initial data, including an initial input vector 31 of the two input quantities, and an initial output vector 33 of the two output quantities, wherein, in the second step S2, an actual output vector 35 of the two output quantities is measured upon controlling the at least one power source 3 with the actual control vector 11.

The first and second steps S1 and S2 are repeated, wherein, in the first step S1, the initial input vector 31 is updated with the actual control vector 11, and the initial output vector 33 is updated with the actual output vector 35.

In an embodiment, the historical data may be provided prior to operating the microgrid 1. Optionally, the historical data is provided from prior test runs or a simulation. Additionally, or in the alternative, the historical data may be collected and updated during operation of the microgrid 1.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for operating a microgrid, wherein the method comprises the steps of:
calculating, based on historical data including a historical input vector of at least one input quantity, a historical output vector of at least two output quantities of the microgrid, and a reference trajectory including a plurality of target values for the at least two output quantities, a control input vector by minimizing a deviation between the plurality of target values and a predicted output vector, the microgrid including at least one power source and at least one dynamic load, the at least one power source and the at least one dynamic load being electrically coupled via an AC bus as a common connecting point; and
controlling the at least one power source with at least a subset of the control input vector as an actual control vector;
wherein the at least two output quantities include a voltage amplitude and a frequency at the AC bus, and the reference trajectory includes a plurality of nominal values for the voltage amplitude and the frequency as the plurality of target values.

2. The method according to claim 1, wherein:
(a) in the step of calculating, the control input vector is calculated further based on an initial input vector of the at least one input quantity and an initial output vector of the at least two output quantities;
(b) in the step of controlling, an actual output vector of the at least two output quantities is measured upon controlling the at least one power source with the actual control vector; and
(c) the step of calculating and the step of controlling are repeated, wherein in the step of calculating the initial input vector is updated with the actual control vector, and the initial output vector is updated with the actual output vector.

3. The method according to claim 1, wherein the control input vector is calculated in the step of calculating using a direct data driven or behavioral predictive algorithm.

4. The method according to claim 3, wherein Data-Enabled Predictive Control (DeePC) is used as the direct data driven or behavioral predictive algorithm.

5. The method according to claim 1, wherein at least two input quantities are used as the at least one input quantity.

6. The method according to claim 5, wherein the at least two input quantities are an active power and a reactive power.

7. The method according to claim 1, wherein, as the control input vector, a sequence of N>1 subsequent control vectors is calculated.

8. The method according to claim 7, wherein only a subset of k<N of the subsequent control vectors are used as the actual control vector, wherein at least one of (a) Nis from 5 to 70, and (b) k is from 1 to 3.

9. The method according to claim 1, wherein, as the at least one power source, a grid forming voltage source converter is controlled.

10. The method according to claim 9, wherein additionally at least one grid following voltage source converter is controlled as a further power source of the at least one power source.

11. The method according to claim 1, wherein the at least one power source (3) is: (a) at least one of a constant power source and a controllable power source; or (b) a variable power source.

12. The method according to claim 1, wherein the historical data is at least one of: (a) provided prior to operating the microgrid; and (b) collected and updated during operation of the microgrid.

13. The method according to claim 12, wherein the historical data is provided prior to operating the microgrid from a plurality of prior test runs or a simulation.

14. The method according to claim 1, wherein the microgrid is operated in an island mode.

15. A control device for controlling a microgrid, the control device comprising:
the control device, which is configured to carry out a method for operating a microgrid, which includes at least one power source and at least one dynamic load, the at least one power source and the at least one dynamic load being electrically coupled via an AC bus as a common connecting point, wherein the method includes the steps of:
calculating, based on historical data including a historical input vector of at least one input quantity, a historical output vector of at least two output quantities of the microgrid, and a reference trajectory including a plurality of target values for the at least two output quantities, a control input vector by minimizing a deviation between the plurality of target values and a predicted output vector; and
controlling the at least one power source with at least a subset of the control input vector as an actual control vector;
wherein the at least two output quantities include a voltage amplitude and a frequency at the AC bus, and the reference trajectory includes a plurality of nominal values for the voltage amplitude and the frequency as the plurality of target values.

16. The control device according to claim 15, wherein the control device includes a computer program, including instructions which, when the computer program is executed by a computer, cause the computer to carry out the method.

17. A microgrid, comprising:
at least one power source;
at least one dynamic load;
a common connecting point formed as an AC bus, the at least one power source and the at least one dynamic load being electrically coupled via the AC bus as the common connecting point; and
a control device configured for controlling the microgrid, the control device being configured to carry out a method for operating the microgrid, the control device being operatively connected to, and configured to control, the at least one power source, the method including the steps of:
calculating, based on historical data including a historical input vector of at least one input quantity, a historical output vector of at least two output quantities of the microgrid, and a reference trajectory including a plurality of target values for the at least two output quantities, a control input vector by minimizing a deviation between the plurality of target values and a predicted output vector; and
controlling the at least one power source with at least a subset of the control input vector as an actual control vector;
wherein the at least two output quantities include a voltage amplitude and a frequency at the AC bus, and the reference trajectory includes a plurality of nominal values for the voltage amplitude and the frequency as the plurality of target values.

18. The microgrid according to claim 17, wherein the microgrid further includes, as the at least one power source, an energy storage device and a voltage source converter in combination therewith.

19. The microgrid according to claim 17, wherein the microgrid further includes a photovoltaic plant as the at least one power source.
